(19) United States
(12) Patent Application Publication
(10) Pub. No.: US 2020/0279149 A1
(43) Pub. Date: Sep. 3, 2020

(54) METHOD FOR REINFORCEMENT LEARNING USING VIRTUAL ENVIRONMENT GENERATED BY DEEP LEARNING

(71) Applicant: AIDENTIFY CO., LTD., Gyeonggi-do (KR)

(72) Inventors: Euijoong Kim, Gyeonggi-do (KR); Soowha Hong, Gyeonggi-do (KR); Junpyo Lee, Seoul (KR); Ilgyu Lee, Seoul (KR)

(21) Appl. No.: 16/802,764

(22) Filed: Feb. 27, 2020

(30) Foreign Application Priority Data
Feb. 28, 2019 (KR) 10-2019-0023870

(51) Int. Cl. G06N 3/04; G06N 20/00; G06F 17/16

(52) U.S. Cl. CPC G06N 3/0454; G06F 17/16; G06N 20/00

(57) ABSTRACT

A method for reinforcement learning using a virtual environment generated by deep learning includes performing, by a first artificial intelligence module, reinforcement learning of a first artificial neural network using a second artificial neural network of a second artificial intelligence module as the virtual environment, determining, after the reinforcement learning of the first artificial neural network is completed, by the first artificial intelligence module, a control command by applying sensing information received from a sensor of a control environment to the first artificial neural network, and providing, by the first artificial intelligence module, the control command to an actuator so that the actuator of the control environment is able to control a control target of the control environment according to the control command.

### CROSS-REFERENCE TO RELATED APPLICATION

This application claims priority from Korean Patent Application No. 10-2019-0023870 filed on Feb. 28, 2019 in the Korean Intellectual Property Office, and all the benefits accruing therefrom under 35 U.S.C. 119, the contents of which in its entirety is herein incorporated by reference.

### BACKGROUND

### 1. Technical Field

The present disclosure relates to a method for reinforcement learning using a virtual environment generated by deep learning, and more specifically to a method for reinforcement learning through a virtual environment generated using actual measurement data.

### 2. Description of the Related Art

Artificial intelligence is a field of computer science and information technology that studies how to enable computers to do thinking, learning, and self-development that humans may do, and refers to enable the computers to imitate human intelligent action.

Recently, machine learning technology that predicts the future by analyzing huge big data is attracting attention. Machine learning is similar to big data analytics in that it collects and analyzes data to predict the future. However, the machine learning differs from the big data analysis in that the computers may collect and learn huge amounts of data on their own. This is a field of the artificial intelligence, which is spotlighted as a core technology of big data.

The annual server power consumption of data centers is over 40 million kWh for large data centers, which is equivalent to millions of dollars in expenses. The power consumption of the entire air conditioning system of the data center ranges from 12% (PUE 1.12, overseas advanced data center average) to 166% (PUE 2.66, domestic data center average), depending on the degree of optimization. This corresponds to a range from about 5 million kWh to 66 million kWh, and the range is large. Therefore, there is much room for cost reduction. Such a large difference in the power consumption of the air conditioning systems in the overall system may be due to the difference in data center design. However, more important is the inability to control the air conditioning systems efficiently.

### SUMMARY

The technical problem to be solved by the present disclosure is to provide a method for reinforcement learning using a virtual environment generated by deep learning, in which an artificial intelligence module reinforcement learned through the virtual environment may be used to control a control environment in an efficient manner.

In order to achieve the object described above, the present disclosure provides a method for reinforcement learning using a virtual environment generated by deep learning including: performing, by a first artificial intelligence module, reinforcement learning of a first artificial neural network using a second artificial neural network of a second artificial intelligence module as the virtual environment; determining, after the reinforcement learning of the first artificial neural network is completed, by the first artificial intelligence module, a control command by applying sensing information received from a sensor of a control environment to the first artificial neural network; and providing, by the first artificial intelligence module, the control command to an actuator so that the actuator se the control environment is able to control a control target of the control environment according to the control command.

In addition, the present disclosure provides a method for reinforcement learning using a virtual environment generated by deep learning including: receiving, by a second Artificial intelligence module, pre-stored actual measurement data from a control environment, learning, by the second artificial intelligence module, the second artificial neural network by determining a weight of the second artificial neural network including a multi layered perceptron based on the actual measurement data; performing, after the second artificial intelligence module learns the second artificial neural network, by a first artificial intelligence module, reinforcement learning of a first artificial neural network using the second artificial neural network as the virtual environment to determine a policy for maximizing an expected value of the sum of rewards corresponding to action information; determining, after the reinforcement learning of the first artificial neural network is completed, by the first artificial intelligence module, a control command by applying sensing information received from a sensor of the control environment to the first artificial neural network; and providing, by the first artificial intelligence module, the control command to an actuator so that the actuator of the control environment is able to control a control target of the control environment according to the control command; in which performing the reinforcement learning of the first artificial neural network determines the policy for maximizing the expected value of the sum of the rewards based on either of a Q-learning method and policy gradient.

According to an embodiment, the second artificial neural network includes a plurality of nodes connected to each other in a matrix form, and may include an input layer to which learning data included in the actual measurement data is input, a hidden layer for applying the weight to the learning data input to the input layer, and an output layer for determining a value output from the hidden layer as a control environment state prediction result.

According to the embodiment, the learning data may include sensing information generated by sensing a control environment state of the control target at a specific point in time and a control command applied to each control target corresponding to the sensing information.

According to the embodiment, the actual measurement data further includes label data, and the label data may include state information of the control environment measured after a predetermined time elapses after the control command is applied to the control target at the specific point in time.

According to the embodiment, learning the second artificial neural network may include: performing, by the second artificial intelligence module, a forward propagation process for generating a control environment state prediction result based on the learning data included in the actual measurement data; and performing a back propagation process for correcting the weight of the second artificial neural network based on an error value that is a difference between the control environment state prediction result generated through the forward propagation process and label data included in the actual measurement data.

According to the embodiment, when the control environment state prediction result is compared with the label data, and the difference between the control environment state prediction result and the label data is larger than a threshold value, performing the back propagation process may perform the back propagation process for correcting the weight so that the difference converges within the threshold value.

According to the embodiment, performing the reinforcement learning of the first artificial neural network may include: providing, by the first Artificial intelligence module, action information according to a policy to the second Artificial intelligence module; calculating, by the second artificial intelligence module, a next state and rewards for the action information by applying the action information to the second artificial neural network; providing, by the second artificial intelligence module, the next state and the rewards to the first artificial intelligence module; and determining, by the first Artificial intelligence module, through a Markov decision process, a policy in which the expected value of the sum of the rewards is maximized.

According to the embodiment, the Q-learning method may be either of Deep Q-Networks and Deep Double Q-networks (DDQN).

According to the embodiment, the Policy Gradient may be any one of Deep Deterministic Policy Gradient, Trust Region Policy Optimization, and Proximal Policy Optimization (PPO).

According to a method for reinforcement learning using a virtual environment generated by deep learning according to an embodiment of the present disclosure, the same virtual environment as a control environment may be generated by using only actual measurement data of the control environment, and reinforcement learning of an artificial neural network may be performed based on the generated virtual environment.

In addition, according to a method for reinforcement learning using a virtual environment generated by deep learning according to an embodiment of the present disclosure, a control environment may be managed under optimal conditions by using an artificial neural network where reinforcement learning is completed.

### BRIEF DESCRIPTION OF THE DRAWINGS

FIG. 1 is a schematic diagram of a system for reinforcement learning using a virtual environment generated by deep learning according to an embodiment of the present disclosure.

FIG. 2 is a diagram for describing a method for reinforcement learning using a virtual environment generated by deep learning according to an embodiment of the present disclosure.

FIG. 3 is a diagram for describing a method for learning a second artificial neural network by a second artificial intelligence module according to the embodiment of the present disclosure.

FIG. 4A is a diagram for describing a forward propagation process of the second artificial neural network according to the embodiment of the present disclosure.

FIG. 4B is a diagram for describing a back propagation process of the second artificial neural network according to the embodiment of the present disclosure.

FIG. 5 is a diagram for describing reinforcement learning of a first Artificial intelligence module according to the embodiment of the present disclosure.

FIGS. 6A and 6B are reward function graphs and show examples of reward design of the first Artificial intelligence module for designing an indoor temperature and a total power consumption of a building under optimal conditions.

FIG. 7 is a flowchart for describing a method for reinforcement learning using a virtual environment generated by deep learning according to an embodiment of the present disclosure.

### DETAILED DESCRIPTION

Hereinafter, embodiments of the present disclosure will be described in detail with reference to the accompanying drawings. However, the embodiments described below are merely to describe in detail enough to be able to easily carry out the invention by those skilled in the art to which the present disclosure pertains, and this does not mean that the protection scope of the present disclosure is limited thereto. In describing various embodiments of the present disclosure, the same reference numerals will be used to refer to elements having the same technical features.

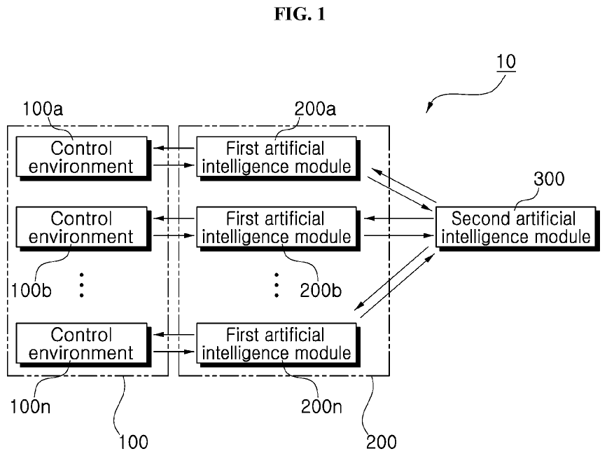

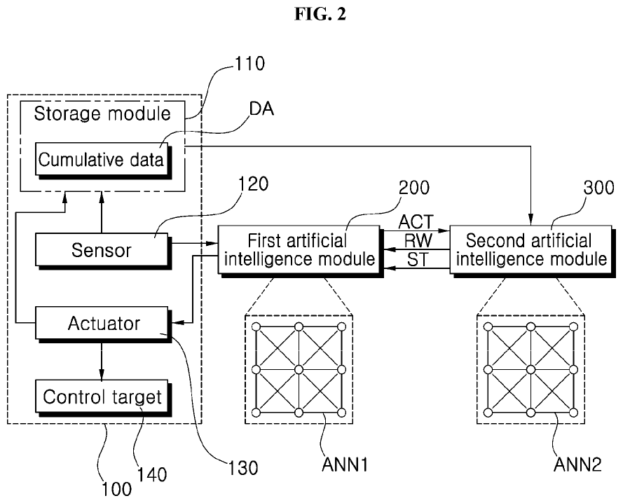

FIG. 1 is a schematic diagram of a system for reinforcement learning using a virtual environment generated by deep learning according to an embodiment of the present disclosure, and FIG. 2 is a diagram for describing a method for reinforcement learning using a virtual environment generated by deep learning according to an embodiment of the present disclosure.

Referring to FIGS. 1 and 2, the system 10 for reinforcement learning using the virtual environment generated by deep learning according to the embodiment of the present disclosure includes a control environment 100, a first artificial intelligence module 200 for controlling each control environment 100, and a second artificial intelligence module 300 for reinforcing training the first artificial intelligence module 200.

The control environment 100 may refer to a series of environments requiring machine control. For example, a first control environment 100a is a temperature control environment for managing an inside temperature of a building, a second control environment 100b is a power control environment for controlling power consumption of a facility, and an n-th control environment 100n may refer to an unmanned crop growing environment that provides nutrients to crops.

The control environment 100 may include a control target 140, an actuator 130 for performing a control command with respect to the control target 140, a sensor 120 for measuring a control state of the control target 140, and a storage module 110 for storing sensing information measured by the sensor 120 and the control command performed by the actuator 130 as actual measurement data DA.

For example, when the control target 140 is an air conditioning facility for managing an inside temperature of a building, the actuator 130 may control the operation of the air conditioning facility in response to a control command. The thermometer sensor 120 may measure an inside temperature of a building, and the storage module 110 may store the inside temperature of the building that changes in response to a control command as actual measurement data DA.

The first Artificial intelligence module 200 may provide a control command to the control environment 100 based on a first artificial neural network ANN1 designed to fit a specific control environment 100. The first artificial intelligence module 200 may receive sensing information on a control state of the control target 140 from the sensor 120, and may determine a control policy for the control target 140 by applying the sensing information to the first artificial neural network (ANN1). The first artificial intelligence module 200 may provide the determined control policy to the actuator 130 as a control command.

In order for the first artificial intelligence module 200 to control the control environment 100 most efficiently, reinforcement learning of the first artificial neural network ANN1 must be preceded. In other words, the reinforcement learning of the first artificial neural network ANN1 must be completed before the first artificial intelligence module 200 controls the control environment 100.

To this end, the second artificial intelligence module 300 may provide a virtual environment for the first artificial intelligence module 200 to perform the reinforcement learning of the first artificial neural network ANN1. The second artificial intelligence module 300 may receive actual measurement data DA generated by controlling the control environment 100 from the control environment 100, and may learn a second artificial neural network ANN2 based on the actual measurement data DA to generate a virtual environment, such as the control environment 100.

Here, the actual measurement data DA means data generated by a person or an existing control system with respect to the control environment. The first artificial intelligence module 200 for performing the reinforcement learning of the first artificial neural network ANN1 means a module which will newly control the control environment 100 by replacing the first artificial intelligence module 200 currently controlling the control environment 100. In other words, the second artificial intelligence module 300 is a module for reinforcement training the first artificial neural network ANN1 of the first artificial intelligence module 200 to be newly introduced into the control environment 100.

The second artificial intelligence module 300 may generate a virtual environment corresponding to the control environment 100 when only the actual measurement data DA provided from each control environment 100 is provided. Therefore, it may provide the virtual environment to the first artificial intelligence module 200 using the actual measurement data DA regardless of the type of the control environment 100.

Upon receiving action information ACT from the first artificial intelligence module 200, the second artificial intelligence module 300 may read a previous state of the virtual environment, and derive a next state ST by applying the action information ACT and the previous state to the second artificial neural network ANN2. In addition, the second artificial intelligence module 300 may calculate a reward RW using at least one of a current state, the next state ST, and action.

The first Artificial intelligence module 200 may perform the reinforcement learning of the first artificial neural network ANN1 using the next state ST and the reward RW.

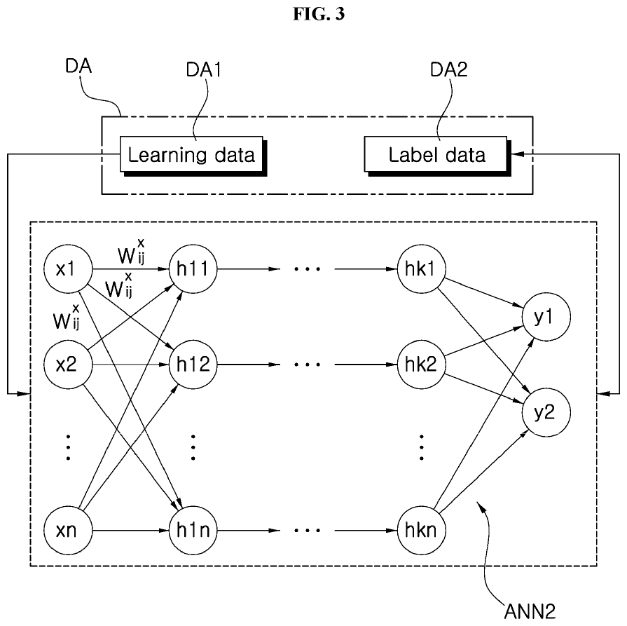

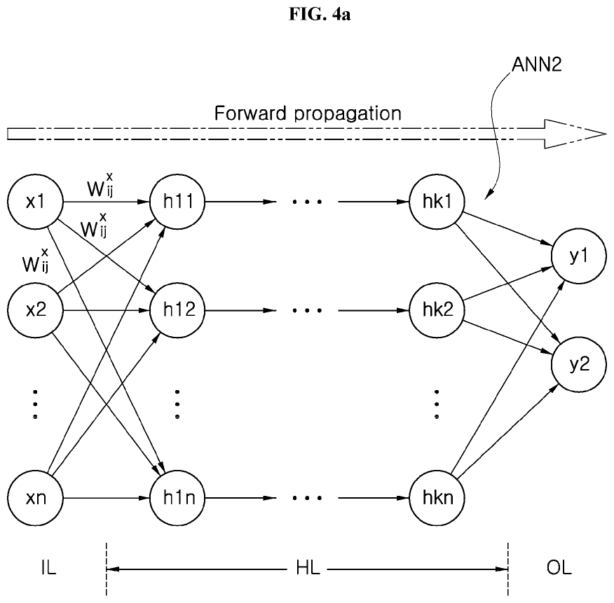

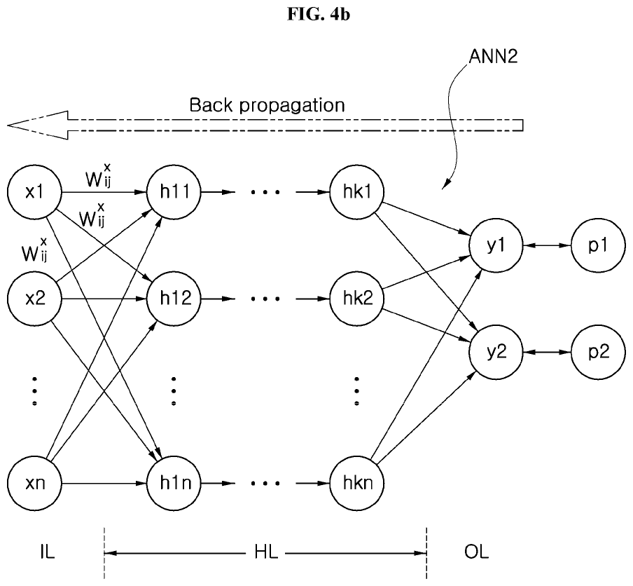

FIG. 3 is a diagram for describing a method for learning the second artificial neural network by the second artificial intelligence module according to the embodiment of the present disclosure. FIG. 4A is a diagram for describing a forward propagation process of the second artificial neural network according to the embodiment of the present disclosure. FIG. 4B is a diagram for describing a back propagation process of the second artificial neural network according to the embodiment of the present disclosure.

Referring to FIG. 3, in order for the second artificial intelligence module 300 to train the first artificial neural network ANN1 of the first artificial intelligence module 200 using the second artificial neural network ANN2, the learning of the second artificial neural network ANN2 must be preceded. To this end, the second artificial intelligence module 300 may train the second artificial neural network ANN2 using actual measurement data DA including sensing information of a control target stored in time series and a control command corresponding thereto.

The actual measurement data DA may include learning data DA1 and label data DA2. The learning data DA1 may include sensing information generated by sensing a control environment state of a control target at a specific point in time, and a control command provided to each control target corresponding to the sensing information. The label data DA2 may include sensing information generated by sensing a control environment after a specific time has elapsed since providing a control command to each control target.

In addition, the sensing information generated by sensing the control environment state includes dependent sensing information that may be changed according to the control of the control target and independent sensing information that changes regardless of the control of the control target. The sensing information included in the learning data DA1 may mean both the dependent sensing information and the independent sensing information. However, the sensing information included in the label data DA2 may mean only the dependent sensing information.

The system 10 for reinforcement learning using the virtual environment generated by the deep learning according to the embodiment of the present disclosure assumes that the actual measurement data DA including the learning data DA1 and the label data DA2 generated over time are pre-generated. A description of a process for generating the actual measurement data DA will be omitted.

The second artificial intelligence module 300 may use a Multi Layered Perceptron, which is a kind of artificial neural network (ANN), as an artificial intelligence algorithm of the second artificial neural network (ANN2). The second artificial neural network ANN2 may include an input layer IL, a hidden layer HL, and an output layer OL including a plurality of nodes.

A learning process of the second artificial neural network (ANN2) includes a forward propagation process, which is a process for deriving a control environment state prediction result using sensor information and a control command input to the input layer IL, and a back propagation process that adjusts a weight of the second artificial neural network (ANN2) to correct the control environment prediction based on label data.

Referring to FIG. 4A, the forward propagation process is shown, in which the learning data DA1 inputted to the input layer IL in the second artificial neural network ANN2 proceeds to the output layer OL through the hidden layer HL, thereby embodying information.

Each node of the input layer IL, the hidden layer HL, and the output layer OL is connected to the preceding layer and the following layer by a node. The learning data DA1 input to the nodes of the input layer IL may be sequentially transferred to the nodes of the output layer OL through the nodes of the hidden layer HL. Each node corresponds to the type of the learning data DA1. Therefore, when specific learning data DA1 is input to the input layer IL, the specific learning data DA1 is transferred to the hidden layer HL and the output layer OL only through corresponding nodes.

If the second artificial neural network (ANN2) has a circulatory neural network form, the input layer IL, the hidden layer HL, and the output layer OL may be extended in a form in consideration of a sequential event. In this case, a transfer path of the learning data DA1 is the input layer IL, the hidden layer HL, and the output layer OL by time. In addition, in the step of the hidden layer HL, a path for transferring information of the previous time point to the output layer OL and the hidden layer HL of the next time point may be added.

In the forward process, the input layer IL functions to receive input data, and the number of nodes of the input layer IL coincides with the number of characteristics of the received learning data DA1. If the number of sensing information and control commands included in the learning data DA1 is 100 in total, the number of nodes of the input layer IL may be 100.

For example, actual measurement data generated to maintain an indoor temperature of a building at an appropriate temperature may be used in the system for reinforcement learning using the virtual environment generated by the deep learning according to the embodiment of the present disclosure.

The actual measurement data DA may include an indoor temperature at a specific time, an outside temperature, the power consumption of an air conditioner, power consumption of other equipment, and a control command provided to a controller at a specific time, as the learning data DA1. In addition, the actual measurement data DA may include an indoor temperature of a building after a predetermined time elapses at a specific point in time and the total amount of power used in a building, as the label data DA2. Here, the indoor temperature and the power consumption of a heating and cooling system to be controlled may be dependent detection information, and the outside temperature and the power consumption of other equipment may be independent sensing information.

The second Artificial intelligence module 300 may input the indoor temperature, the outside temperature, the power consumption of the heating and cooling system, the power consumption of other equipment, and the control command at the specific point in time included in the learning data DA1 to the corresponding nodes of the input layer IL of the second artificial neural network ANN2.

In addition, the learning data DA1 may be transferred to the output layer OL through the hidden layer HL of the second artificial neural network ANN2, in which the nodes of the output layer OL may means prediction results for the room temperature and the total amount of power consumption after a predetermined time since the room temperature, the outside temperature, the power consumption of the heating and cooling equipment, the power consumption of other equipment, and the control command are given at the specific point in time. In other words, the nodes of the output layer OL may represent control environment state prediction results after the predetermined time has passed after the learning data DA1 at the specific point in time is given.

For example, at a first point in time, the indoor temperature of the building may be 28° C., the outside temperature may be 30° C., the power consumption of the cooling equipment may be 100 W, and the power consumption of other equipment may be 150 W. In addition, when there is a control command to activate the cooling equipment to lower the room temperature to 20° C., 28° C. as the room temperature, 30° C. as the outside temperature, 100 W as the power consumption of the cooling equipment, 150 W as the power consumption of other equipment, and the activation of the cooling equipment as the control command may be input to each node of the input layer IL of the second artificial neural network ANN2.

Information input to each node of the input layer IL is transferred to the hidden layer HL, and finally to the nodes of the output layer OL. A value transferred to each node of the output layer OL may mean a prediction result of predicting the room temperature and the total power consumption of the building.

Specifically, a first step of forward propagation is to linearly add data received from the previous layer by considering a weight as shown in Equation 1 below.

$$\begin{matrix}{h}_{j}^{1} = sigm ( {\sum }_{ξ = 1}^{i} {ω}_{ξ j}^{x} {x}_{ξ} ) \\ = sigm ( {ω}_{ij}^{x} \cdot {x}_{i} ) \\ = \frac{1}{1 + {e}^{- \text{?}}}\end{matrix} \\ \text{?} \text{indicates text missing or illegible when filed} \qquad < Equation 1 >$$

Where, h1¹ⱼ denotes a node corresponding to a j-th layer of a first layer of the hidden layer HL, and ω^{x}ᵢⱼ denotes a weight applied when the learning data input to the nodes of the input layer IL is transferred to the first layer of the hidden layer HL. Here, i and j are natural numbers, and denote the number of electric signals ES and the number of nodes of the first layer of the hidden layer HL, respectively. xᵢ denotes an i-th node of the input layer IL.

A second step performs forward propagation to nodes of a second layer of the hidden layer HL by applying the summated value at each of the nodes of the first layer to Equation 2 below.

$$\begin{matrix}{h}_{k}^{2} = sigm ( {\sum }_{ξ = 1}^{j} {ω}_{ξ k}^{h 1} {h}_{ξ}^{1} ) \\ = sigm ( {ω}_{jk}^{h 1} \cdot {h}_{j}^{1} ) \\ = \frac{1}{1 + {e}^{- {ω}_{jk}^{h 1} \cdot {h}_{j}^{1}}}\end{matrix} \qquad < Equation 2 >$$

Where, h²ₖ denotes a k-th node of the second layer of the hidden layer HL, and ω^{h1}ⱼₖ denotes a weight applied when the calculated value transferred to the second layer of the hidden layer HL is transferred to the second layer of the hidden layer HL Here, k is a natural number, and denotes the number of nodes of the second layer of the hidden layer HL.

The calculated value in this way is transferred to the output layer OL, which is the last layer, and the calculated value transferred to the output layer OL is determined as the control environment state prediction result. In other words, the calculated value output to each node of the output layer OL may mean a prediction result value for the room temperature and the total power consumption.

Therefore, the system 10 for reinforcement learning using the virtual environment generated by the deep learning of the present disclosure may determine the control environment state prediction result using the learning data DA1 included in the actual measurement data DA using the second artificial neural network ANN2.

Referring to FIG. 4B, the back propagation process is shown, in which the weight of the second artificial neural network ANN2 is adjusted to correct the control environment state prediction result based on the label data DA2. The control environment prediction result is a result of predicting a state of a control target environment after a predetermined time in an environment according to the learning data DA. Therefore, the result of the control environment state prediction may differ somewhat from an actual measurement value. Here, the actual measurement value corresponds to the label data DA2 of the actual measurement data DA, in which the second Artificial intelligence module 300 may perform the back propagation process to correct the difference between the control environment state prediction result and the actual measurement value using the label data DA2.

Specifically, when the difference between the control environment state prediction result calculated by the second artificial neural network ANN2 based on the learning data DA1 and the label data DA2 exceeds a threshold value, the second artificial intelligence module 300 may adjust the weight of the second artificial neural network ANN2 such that an error value converges within the threshold value through the back propagation process.

Equation 3 below is an objective function for the back propagation process. It calculates the error values, which are the difference between the control environment state prediction result and the label data DA2, and squares the error values, sums them all up, and calculates a mean value.

$$Loss = \frac{1}{N} {\sum }_{t = 1}^{N} {error}^{2} = \frac{1}{N} {\sum }_{t = 1}^{N} {( {y}_{i} - {p}_{i} )}^{2} \qquad < Equation 3 >$$

Where, N denotes the learning data DA1, error denotes the error value that is the difference between the control environment state prediction result and the label data DA2, yᵢ denotes the label data DA2, and pᵢ denotes the control environment state prediction result.

This back propagation process is a process for repeatedly correcting weights between nodes while feeding backward the error value. As a neural network learning process is progressed through repetitive back propagation, it increases the accuracy of the control environment state prediction result. Ultimately, when the error value converges within a threshold, the second artificial intelligence module 300 completes the learning, the weight included in the second artificial neural network ANN2 is fixed, and it becomes a completed artificial neural network for predicting the control environment state prediction result.

Weight correction to complete the second artificial neural network (ANN2) is to update the weight between each node in the process of back propagation to minimize the error value. First, when the second artificial neural network (ANN2) is defined, it is possible to initialize the weight connected to each layer.

Here, initializing it with the Xavier_Glolot algorithm will result in an efficient convergence at the beginning. When the weight is initialized, it starts learning.

By reading the sensing information and the control command from the learning data included in the actual measurement data and feeding forward it through the second artificial neural network (ANN2), it is possible to obtain the control environment state prediction result for the inside temperature and the total power consumption.

$$Loss = - \frac{1}{N} {\sum }_{i = 1}^{N} ( {y}_{i} log {p}_{i} ) \qquad < Equation 4 >$$

Equation 4 relates to a method for obtaining a loss value using cross entropy. Here, Loss is that an error value calculated from the difference between a prediction result and an actual measurement value of an exhaust gas is defined as a loss value. The loss value may be defined by calculating the control environment state prediction result and the label data DA2 by the cross entropy.

In addition, in the neural network learning process, Gradient Descent according to Equation 5 may be used as a method for finding a weight that minimizes the loss value.

$${w}_{t + 1} = {w}_{t} - α \frac{\partial L o s s}{\partial {w}_{t}} \qquad < Equation 5 >$$

Where, α is a learning rate, and is a coefficient for determining how much to move when calculating the convergence equation. The learning rate may be set to a value that does not vibrate or diverge.

Since all the weights that minimize the loss value cannot be obtained at once, a correction value may be obtained while transferring an error for each layer. Here, a chain rule may be used, in which a first weight to calculate is a weight connected to the output layer OL.

For example, after a third weight ω₃ is calculated by substituting the loss value calculated in Equation 4 into Equation 5, a second weight ω₂ which is a weight of the next layer may be obtained. Here, the chain rule is a method for obtaining the second weight ω₂ by using the third weight ω₃ previously obtained as a parameter.

The neural network learning method performs a process for updating the weights connected to each layer while feeding backward the loss value, which is the error, using the chain rule. Ultimately, the learning is complete when the weights converge.

As such, the second artificial intelligence module 300 according to the embodiment of the present disclosure may complete the learning of the second artificial neural network ANN2 by using the pre-generated actual measurement data DA. Subsequently, when the second artificial intelligence module 300 receives information corresponding to the learning data DA from the first artificial intelligence module 200, the second artificial intelligence module 300 may calculate a reward value through the second artificial neural network ANN2 and provide it to the first artificial intelligence module 200.

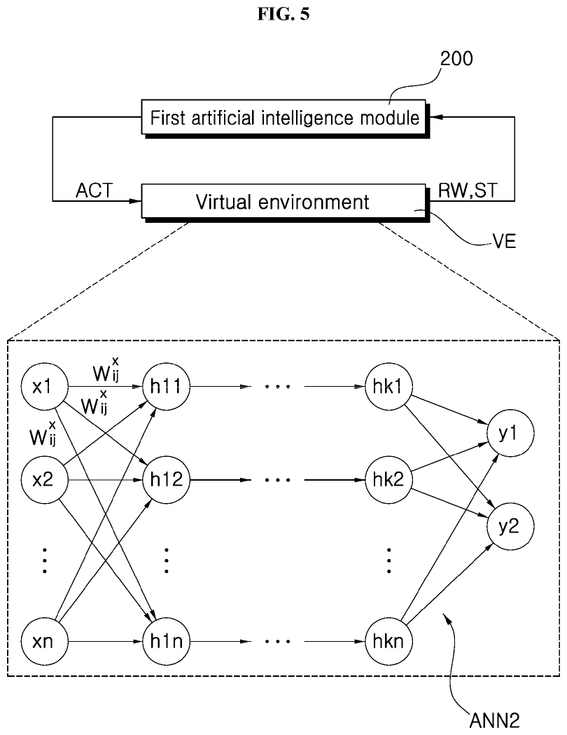

FIG. 5 is a diagram for describing reinforcement learning of a first artificial intelligence module according to the embodiment of the present disclosure.

Referring to FIG. 5, the second artificial intelligence module 300 may provide a virtual environment VE for the reinforcement learning of the first Artificial intelligence module 200. Here, the virtual environment VE may mean the second artificial neural network ANN2 that outputs a reward value in response to action information according to a policy input from the first artificial intelligence module 200.

The first artificial intelligence module 200 may perform the reinforcement learning of the first artificial neural network ANN1 using the second artificial neural network ANN2 of the second artificial intelligence module 300. The second artificial intelligence module 300 is a virtual environment module, and is used to infer a virtual environment by performing deep learning based on real environment data. However, the first artificial intelligence module 200 is a machine learning control module, and may learn a control model through a reinforcement learning process.

The reinforcement learning may be achieved by the Markov Decision Process. The Markov decision process is a mathematical framework for modeling a decision making process, and is a model for the case where the Markov Property is satisfied.

The Markov Property is an attribute in which the probability of the next state is affected only by the previous state. Since most environments follow such an attribute, the Markov decision process is widely applicable in real environments.

An agent in the Markov Decision Process receives a state from an environment and probabilistically determines action according to a policy. When applying the determined action to the environment, each state receives a reward designed appropriately by a learning designer with the next state according to a transition probability, in which the goal of the reinforcement learning is to find an optimal policy that maximizes an expected value of the sum of these rewards.

The sum of the rewards is called return and is calculated as in Equation 6.

$${R}_{t} = {\sum }_{i = t}^{T} {γ}^{( i - t )} r ( {s}_{i} , {a}_{i} ) \qquad < Equation 6 >$$

When a specific action is taken in a specific state, the sum of the expected reward values until the final state is called an expected return value from the initial state, and is calculated as in Equation 7.

J= [symbol] ᵣ_{ᵢ}_{,s}_{ᵢ}_{˜E,a}_{ᵢ}_{˜π}[R₁] <Equation 7>

The sum of the expected reward values from the specific state to the final state is called an action-value function, and is calculated as in Equation 8.

Q_{π}(sₜ,aₜ)= [symbol] ᵣ_{_{i≥t}}_{,s}_{_{i>t}}_{˜E,a}_{_{i>t}}_{˜π}[Rₜ|sₜ,aₜ] <Equation 8>

Evaluating the degree of predominance of the action-value function with state values as a baseline is called a predominance function, and is calculated as in Equation 9.

A_{π}(s,a)=Q_{π}(s,a)−V_{π}(s) <Equation 9>

A reinforcement learning algorithm allows the agent to achieve the goal by maximizing any of the action-value function, the state value function, and the predominance function according to an implementation method thereof. Here, the action-value function may be used for the Deep Deterministic Policy Gradient, and the predominance function may be used for the Trust Region Policy Optimization or the Proximal Policy Optimization.

The first artificial intelligence module 200 according to the embodiment of the present disclosure may use a Q-learning method or the Policy Gradient depending on a characteristic of an action to be controlled for the reinforcement learning of the first artificial neural network ANN1.

The Q-learning method may be any one of value iteration such as Deep Q-Networks, Deep Double Q-Networks, or the like.

Here, the Deep Q-Networks is a method for applying a function approximation to the action-value function, then obtaining an approximate solution of action-value and greedy determining a policy. In the process for applying the function approximation, it uses a multi layered perceptron as an approximation function.

The process for obtaining the approximate solution of the action-value function of the Deep Q-Networks may be divided into three processes.

First, the first process selects an action based on the ε-greedy algorithm according to Equation 10, and feeds forward a state and a selected action to the Q-Network to obtain an action-value (Q, action-value).

Q(sᵢ, aᵢ|θ) <Equation 10>

In the second process, it applies the selected action to an environment according to Equation 11 to obtain a state and reward at the next unit time, and then, feeds forwards the obtained state and the next actions to the Q-Network to obtain a maximum action-value at the next unit time, and performs a process for obtaining an action-value at the current unit time by applying an appropriate discount factor to the obtained action-value and adding it to a reward.

$${r}_{i} + γ {max}_{{a}^{′}} Q ( {s}_{i + 1} , {a}^{′} \vert θ ) \qquad < Equation 11 >$$

The third process is to train the neural network by performing to back propagation a Mean Square Error (MSE) of an action-value in the current unit time obtained from the previous two process with a loss function the according to Equation 12.

$$\frac{1}{N} {\sum }_{i} {\{ {r}_{i} + γ {max}_{{a}^{′}} Q ( {s}_{i + 1} , {a}^{′} \vert θ ) - Q ( {s}_{i} , {a}_{i} \vert θ ) \}}^{2} \qquad < Equation 12 >$$

Through such a series of processes, the first artificial intelligence module 200 may perform the reinforcement learning of the first artificial neural network ANN1.

Through the series of processes, an approximation function similar to an actual action-value function may be obtained, and an optimal action for each state may be obtained by using the same.

The Policy gradient may be any one of policy gradients such as Deep Deterministic Policy Gradient (DDPG), Trust Region Policy Optimization (TRPO), Proximal Policy Optimization (PPO), or the like.

The Deep Deterministic Policy Gradient is a method that introduces an actor-critic algorithm instead of greedy policy making, implements the Deep Q-Network as a critic function Q and an actor function μ with a separate multi layered perceptron, and alternatively trains it.

In the Deep Deterministic Policy Gradient, there are four neural networks: an actor neural network, a target actor neural network, a critic neural network, and a target critic neural network, and internally, there is a playback buffer to store a set of state-action-reward-next state.

First, the first Artificial intelligence module 200 may initialize weights of the actor neural network and the critic neural network to arbitrary values, in which it may initialize the weight of the target actor neural network to the weight of the actor neural network, and may initialize the weight of the target critic neural network to the weight of the critic neural network.

The first Artificial intelligence module 200 may obtain an action by passing an initial state through the actor neural network, and may apply randomness to the action by applying the Orstein-Uhlenbeck process of Equation 13.

aₜ=μ(sₜ|θ^{μ})+Nₜ <Equation 13>

The first artificial intelligence module 200 may obtain a reward and a next state by applying an action to an environment, and may store a series of transitions in a playback buffer in the order of a state, an action, a reward, and a next state.

The first artificial intelligence module 200 may extract a mini-batch of any of the transitions from the playback buffer, and may apply the next state to the target actor neural network based on the extracted mini-batch to obtain an action. Here, a time difference learning label of the action-value may be calculated by applying next states of the action and the mini-batch to the target critic neural network, multiplying a discount rate, and adding a reward of the mini-batch, according to Equation 14 below.

rᵢ+γQ′(sᵢ₊₁,μ′(sᵢ₊₁|θ_{μ},|θ_{Q′})) <Equation 14>

The first Artificial intelligence module 200 may obtain an action-value by applying the state and action of the mini-batch to the critic neural network according to Equation 15, and then, may train the critic neural network by performing the back propagation a mean square error with the time difference learning label of the action-value obtained above, with the loss function.

$$\frac{1}{N} {\sum }_{i} {( {r}_{i} + γ {Q}^{′} ( {s}_{i + 1} , {μ}^{′} ( {s}_{i + 1} \vert {θ}_{{μ}^{′}} \vert {θ}_{{Q}^{′}} ) ) - Q ( {s}_{i} , {a}_{i} \vert {θ}_{Q} ) )}^{2} \qquad < Equation 15 >$$

The first Artificial intelligence module 200 may transfer a gradient provided from the critic neural network to the actor neural network by applying a chain rule to find an action maximizing the action-value according to Equation 16, and may train the actor neural network using the policy gradient.

$${∇}_{{θ}_{μ}} J \approx \frac{1}{N} {\sum }_{i} {∇}_{a} Q ( s , a \vert {θ}_{Q} ) {\vert}_{s = {s}_{i} , a = μ ( {s}_{i} )} {∇}_{{θ}_{μ}} μ ( s \vert {θ}_{μ} ) {\vert}_{{s}_{i}} \qquad < Equation 16 >$$

Finally, the first Artificial intelligence module 200 may update the target critic neural network and the target actor neural network with appropriate coefficients by using the critic neural network and the actor neural network.

θ_{Q′}←τθ+(1−τ)θ_{Q′},θ_{μ′}←τ_{μ}+(1−τ)θ_{μ′} <Equation 17>

As such, the first artificial intelligence module 200 may repeatedly perform the processes above, and may complete the reinforcement learning of the first artificial neural network ANN1 by the Q-learning method or the policy gradient using the reward RW provided from the second artificial intelligence module 300. When the reinforcement learning of the first artificial neural network (ANN1) is completed, the first artificial intelligence module 200 may stop the connection with the virtual environment VE of the second artificial intelligence module 300, and be directly put into the control environment 100.

After the first artificial intelligence module 200 is directly put into the control environment 100, it may be provided with sensing information on a control state of the control target 140 from the sensor 120, and may control the control target 140 to an optimum condition by providing the actuator with a control command determined by applying the sensing information to the first artificial neural network ANN1.

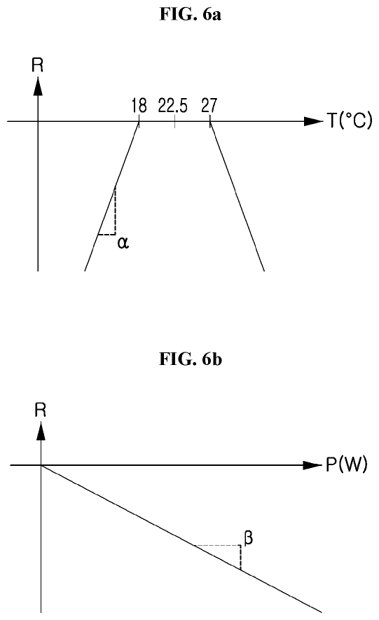

FIGS. 6A and 6B are reward function graphs and show examples of reward design of the first Artificial intelligence module for designing an indoor temperature and a total power consumption of a building under optimal conditions.

Referring to FIGS. 6A and 6B, reward graphs for the first artificial intelligence module 200 to optimally control the indoor temperature and the total power consumption of the building are shown.

When the first artificial intelligence module 200 provides an action information ACT, which is a virtual control command, to the second artificial intelligence module 300, the second artificial intelligence module 300 may apply it to the second artificial neural network ANN2 by reading a previous state (for example, an indoor temperature, an outside temperature, power consumption of a cooling and heating equipment, and power usage of other equipment).

The second artificial neural network ANN2 of the second artificial intelligence module 200 may calculate a next state ST (e.g., the room temperature of the building and the total power consumption generated by the building after a certain time has elapsed) and a reward RW based on the action information ACT for the previous state (for example, the indoor temperature, the outside temperature, the power consumption of the cooling and heating equipment, and the power usage of other equipment).

The first artificial intelligence module 200 may receive the reward RW and the next state ST from the second artificial intelligence module 300, and may perform the reinforcement learning of the first artificial neural network ANN1 based on the reward RW and the next state ST. Here, the first artificial intelligence module 200 may perform the reinforcement learning to maximize the expected value of the sum of the calculated rewards by applying the reward RW and the next state ST to predesigned reward graphs.

After completing the reinforcement learning using the reward graphs, the first Artificial intelligence module 200 may actually control the control environment 100 based on information provided from the control environment 100.

For example, it is desirable to minimize the total power consumption while maintaining the indoor temperature between 18° C. and 27° C. Therefore, the first artificial intelligence module 200 may apply the reward RW and the next state ST provided from the second artificial intelligence module 300 to the reward graph, and may perform the reinforcement learning to maximize the expected value of the sum of the rewards obtained through the reward graphs.

In other words, the first artificial intelligence module 200 may perform the reinforcement learning of the first artificial neural network ANN1 using the reward graphs to generate a control command for keeping the indoor temperature of the building between 18° C. and 27° C. while minimizing the total power consumption.

Here, a reward function for the indoor temperature is given by Equation 18. The reward function for the total power consumption may be designed as shown in Equation 19. An overall reward function may be calculated as in Equation 20 and optimized for multiple

$${R}_{temp} ( T ) = \{ \begin{matrix}( T - 18 ) , & ( T < 18 ) \\ ( 27 - T ) , & ( 27 < T ) \\ 0 , & ( 18 \leq T \leq 27 )\end{matrix} \qquad < Equation 18 >$$

purposes at the same time.

R_{power}(P)=−P <Equation 19>

Rₛᵤₘ=αRₜₑₘₚ(T)+βR_{power}(P) <Equation 20>

When the first artificial intelligence module 200 provides an action information ACT, which is a virtual control command, to the second artificial intelligence module 300, the second artificial intelligence module 300 may apply it to the second artificial neural network ANN2 by reading a previous state (for example, an indoor temperature, an outside temperature, power consumption of a cooling and heating equipment, and power usage of other equipment).

The second artificial neural network ANN2 of the second artificial intelligence module 200 may calculate the next state ST (e.g., the room temperature of the building and the total power consumption generated by the building after the certain time has elapsed) and the reward RW based on the action information ACT for the previous state (for example, the indoor temperature, the outside temperature, the power consumption of the cooling and heating equipment, and the power usage of other equipment), and may calculate the reward R) according to a reward design based on combined information (e.g., the room temperature of the building and the total power consumption generated by the building after the certain time has elapsed) of some of information of the previous state, action ACT, and next state ST.

The first artificial intelligence module 200 may receive the reward RW and the next state ST from the second artificial intelligence module 300, and may perform the reinforcement learning of the first artificial neural network ANN1 by applying the reward RW and the next state ST to the reward graphs.

When the reinforcement learning of the first artificial neural network (ANN1) is completed, the first artificial intelligence module 200 may stop the connection with the virtual environment VE of the second artificial intelligence module 300, and be directly put into the control environment 100.

After the first artificial intelligence module 200 is directly put into the control environment 100, it may be provided with sensing information on a control state of the control target 140 from the sensor 120, and may control the control target 140 to an optimum condition by providing the actuator with a control command determined by applying the sensing information to the first artificial neural network ANN1 where the learning is completed.

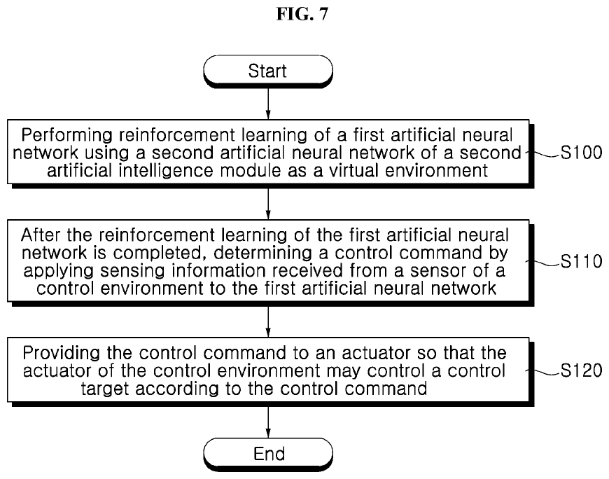

FIG. 7 is a flowchart for describing a method for reinforcement learning using a virtual environment generated by deep learning according to an embodiment of the present disclosure.

Referring to FIG. 7, the first artificial intelligence module 200 may perform the reinforcement learning of the first artificial neural network ANN1 using the second artificial neural network ANN2 of the second artificial intelligence module 300 as the virtual environment VE (S100).

After the reinforcement learning of the first artificial neural network (ANN1) is completed, the first artificial intelligence module 200 may determine the control command by applying the sensing information received from the sensor 120 of the control environment 100 to the first artificial neural network ANN1 (S110).

The first Artificial intelligence module 200 may provide the control command to the actuator 130 so that the actuator 130 of the control environment 100 may control the control target according to the control command (S120).

Although the embodiments of the present disclosure have been described above, it is understood that those skilled in the art to which the present disclosure pertains may make various modifications without departing from the claims of the present disclosure.

What is claimed is:

1. A method for reinforcement learning using a virtual environment generated by deep learning, the method comprising:
performing, by a first artificial intelligence module, reinforcement learning of a first artificial neural network using a second artificial neural network of a second artificial intelligence module as the virtual environment;
determining, after the reinforcement learning of the first artificial neural network is completed, by the first artificial intelligence module, a control command by applying sensing information received from a sensor of a control environment to the first artificial neural network; and
providing, by the first artificial intelligence module, the control command to an actuator so that the actuator of the control environment is able to control a control target of the control environment according to the control command.

2. A method for reinforcement learning using a virtual environment generated by deep learning, comprising:
receiving, by a second artificial intelligence module, pre-stored actual measurement data from a control environment;
learning, by the second artificial intelligence module, the second artificial neural network by determining a weight of the second artificial neural network including a multi layered perceptron based on the actual measurement data;
performing, after the second artificial intelligence module learns the second artificial neural network, by a first artificial intelligence module, reinforcement learning of a first artificial neural network using the second artificial neural network as the virtual environment to determine a policy for maximizing an expected value of the sum of rewards corresponding to action information;
determining, after the reinforcement learning of the first artificial neural network is completed, by the first artificial intelligence module, a control command by applying sensing information received from a sensor of the control environment to the first artificial neural network; and
providing, by the first artificial intelligence module, the control command to an actuator so that the actuator of the control environment is able to control a control target of the control environment according to the control command,
wherein performing the reinforcement learning of the first artificial neural network determines the policy for maximizing the expected value of the sum of the rewards based on either of a Q-learning method and policy gradient.

3. The method of claim 2, wherein the second artificial neural network comprises a plurality of nodes connected to each other in a matrix form, and comprises an input layer to which learning data included in the actual measurement data is input, a hidden layer for applying the weight to the learning data input to the input layer, and an output layer for determining a value output from the hidden layer as a control environment state prediction result.

4. The method of claim 3, wherein the learning data comprises the sensing information generated by sensing a control environment state of the control target at a specific point in time and the control command applied to each control target corresponding to the sensing information.

5. The method of claim 4, wherein the actual measurement data further comprises label data, and
wherein the label data comprises state information of the control environment measured after a predetermined time elapses after the control command is applied to the control target at the specific point in time.

6. The method of claim 2, wherein learning the second artificial neural network comprises:
performing, by the second artificial intelligence module, a forward propagation process for generating a control environment state prediction result based on learning data included in the actual measurement data; and
performing a back propagation process for correcting the weight of the second artificial neural network based on an error value that is a difference between the control environment state prediction result generated through the forward propagation process and label data included in the actual measurement data.

7. The method of claim 6, when the control environment state prediction result is compared with the label data and then the difference between the control environment state prediction result and the label data is larger than a threshold value, performing the back propagation process performs the back propagation process for correcting the weight so that the difference converges within the threshold value.

8. The method of claim 2, wherein performing the reinforcement learning of the first artificial neural network comprises:
providing, by the first artificial intelligence module, action information according to a policy to the second artificial intelligence module;
calculating, by the second artificial intelligence module, a next state and rewards for the action information by applying the action information to the second artificial neural network;
providing, by the second artificial intelligence module, the next state and the rewards to the first artificial intelligence module; and
determining, by the first artificial intelligence module, through a Markov decision process, a policy in which the expected value of the sum of the rewards is maximized.

9. The method of claim 2, wherein the Q-learning method may be either of Deep Q-Networks and Deep Double Q-networks (DDQN).

10. The method of claim 2, wherein the policy gradient is any one of Deep Deterministic Policy Gradient, Trust Region Policy Optimization, and Proximal Policy Optimization (PPO).
